(19) United States
(12) Patent Application Publication
(10) Pub. No.: US 2011/0087953 A1
(43) Pub. Date: Apr. 14, 2011

(54) Automated embeddable searchable static rendering of a webpage generator

(76) Inventor: Anton C. Grohs, Milwaukie, OR (US)

(21) Appl. No.: 12/575,721

(22) Filed: Oct. 8, 2009

(51) Int. Cl. G06F 17/00

(52) U.S. Cl. 715/205; 715/234

(57) ABSTRACT

A computer program that creates a static rendering of a web page as an image and as text representing the page, by rendering an image of the web page from a web browser, storing the image on a server, extracting only the readable text from the source of the web page, and creating embeddable code that displays the stored image via HTML IMG tag and plain text parsed from the web page source, preferably separating each word by single spaces. Thus, allowing the programs user to input the URL of a web page, and as a function, return to the user code that can be placed within multiple internet e-commerce communities, that is both visually representative of the page and fully searchable using the technology of today's full text search, while preserving the security implemented within these controlled environments.

### SUMMARY OF THE INVENTION

A computer program that creates a static rendering of a web page as an image and as text representing the page, by rendering an image of the web page from a web browser, storing the image on a server, extracting only the readable text from the source of the web page, and creating embeddable code that displays the stored image via HTML IMG tag and plain text parsed from the web page source, preferably separating each word by single spaces. Thus, allowing the programs user to input the address of a web page, and as a function, return to the user code that can be placed within multiple internet e-commerce communities including EBay and Craigslist, that is both visually representative of the page and fully searchable using the technology of today's full text search, while preserving the security implemented within these controlled environments.

### BACKGROUND OF THE INVENTION

1. Field of the Invention

The present invention relates to the field of internet marketing and the dispersal of information within a secured controlled environment, which is inherently design limiting.

2. Background Information

With the advances in internet commerce and the web community it is often desirable to reference a web page marketing goods or services. Each page selling goods or services ideally has been designed to best represent that good or service to the best of the ability of the web designer and owner(s) of the page.

### DESCRIPTION OF THE INVENTION

The User uses a local internet browser to communicate with the server using standard HTTP protocol. The user and browser together will be referred to as client for the duration of this description. The server processes requests from the client using a web server. In one embodiment the web server could be Apache. The server receives data from the client using the standard HTTP protocol HTML POST and GET Methods. The client submits a URL to the server using a HTML form. The URL is then opened in a browser local to the server using any GUI operating system. The content of the browsers window is then captured as an image. This operation can be done in many ways depending on the operating system being used. One embodiment would be to use the Windows operating system, Perl programming language, and the Win32::Clipboard and Win32::GuiTest Perl modules. Another embodiment could use the Linux Operating system running X windows using the Ice Weasel browser using Perl or Python or Ruby as the programming language to manipulate GIMP and ImageMagick at the command line, to capture the image. The image is then stored in a public directory accessible from the internet.

The server then downloads the source of the URL received by the client. This can be accomplished in many ways using many languages and many operating systems. In one embodiment the programming language could be Perl using the LWP::Simple Module. Once the source has been downloaded by the server the source is then parsed, removing all HTML, Javascript, and CSS code, then all strings of multiple of tabs and spaces are reduced to one space. In one embodiment this is accomplished with the Perl programming language and Regular expression See FIG. 3. The server then creates HTML code for the user including an IMG tag with SRC set to the image saved in the public directory accessible from the internet encapsulated with a hyperlink. See FIG. 1. It then adds the parsed source text. See FIG. 2. This HTML is then made available to the user. In one embodiment this is accomplished by displaying the code within an HTML TEXTAREA served to the client from the server.

### DESCRIPTION OF FIGURES

FIG. 1 is an example of a simple form of HTML or hyper text markup language. This HTML snippet tells the browser to show the image served from the location on the internet located at a web address. Furthermore the snippet shows the image is incased in a link reference. Allowing the web browser to know what page it should change to if the image is clicked on and the link is followed. The web address is referenced with HREF as shown in the snippet.

FIG. 2 is identical to FIG. 1 with the exception of additional text added below the image but within the link hierarchy. This text is created using the methods described within the description and claims of the invention.

FIG. 3 shows on the first line that it is the PERL programming language that is being used to process the script. On the second line shows a string identified as $text is now filled with the information stored within string $source. $source was filled with the textual data located at the URL described in the description. The remaining lines are examples of REGEX. REGEX is a standard used in most current languages. It allows the programmer to describe using a standard set of symbols what he would like to do with a data set. In this form it shows that the string $text will be modified be substituting anything in the first set of slashes with anything in the between the second set. “$text=˜s/\n//g;” for example takes all occurrences of “\n”(the symbol for carriage return or enter) and replaces it with “”(nothing) effectively removing all occurrences of a new line. After each line in FIG. 3 is a standard comment describing in brief detail what action is being accomplished by each REGEX.

1. A method to create a searchable static rendering of a web page in a portable format, the method comprising a static image of the web page as rendered by a web browser; And complete text from the web page, filtering out the HTML, JavaScript, and CSS tags.

2. The method of claim 1, wherein HTML CSS code is created including an image tag with source or SRC of said rendering, as an image, addressed to the image hosted on a web server.

3. The method of claim 2, wherein said rendering is encapsulated by a hyperlink addressed to said web page.

4. The method of claim 2, wherein said text is encapsulated by a hyperlink addressed to said web page.

5. The method of claim 1, wherein any string of spaces within said text is reduced to one space.

6. The method of claim 1, wherein HTML is removed from said text.

7. The method of claim 1, wherein JavaScript is removed from said text.

8. The method of claim 1, wherein CSS is removed from said text.

9. The method of claim 1, wherein New line Carriage Return is removed from said text.
